(19) United States
(12) Patent Application Publication
(10) Pub. No.: US 2008/0271425 A1
(43) Pub. Date: Nov. 6, 2008

(54) Apparatus and method for automatically coupling of electrical and hyraulic systems of a header of an agricultural harvesting machine

(76) Inventors: Jonathan E. Ricketts, Ephrata, PA (US); Bradley J. Wagner, Wrightsville, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 11/799,123

(22) Filed: May 1, 2007

(51) Int. Cl. A01D 34/40; A01D 34/00

(52) U.S. Cl. 56/15.6; 56/14.6

(57) ABSTRACT

Apparatus and method for automatically coupling fluid systems and electrical systems, respectively, of a header and a feeder of an agricultural combine as the header is lifted by the feeder. The feeder and header include lifting elements pivotably engageable with lower portions of the feeder and header spaced apart, such that when the feeder is raised, the header will be lifted by the feeder and pivoted so as to bring the lower portions together. A first coupler block is supported on the feeder and includes at least one fluid coupler and at least one electrical contact, and a second coupler block is supported on the header and also includes at least one fluid coupler and at least one electrical contact. The fluid couplers and the electrical contacts are configured and positioned so as to couple and be brought into contact, respectively, as the lower portions of the feeder and the header are brought together. They can also automatically uncouple when the header is removed from the feeder.

### TECHNICAL FIELD

This invention relates to apparatus and a method for automatically connecting electrical and hydraulic systems, respectively, of a header and an agricultural harvester such as a combine, windrower or the like, and more particularly, which provides hands-free, automatic coupling of couplers or connectors of the respective systems, as the header is installed on the harvester, and hands-free, automatic decoupling and disconnection when that header is removed.

### BACKGROUND ART

Agricultural combines are typically configured for interchangeable connection of different headers to a feeder on the front end of the combine, for harvesting different types of crops from a field. For example, one type of header will be used for harvesting corn or maize, and another for smaller grains, such as soy beans, rice and wheat. For some applications, headers are required to be installed and removed by a person working alone. And, in some instances, installation and removal must be done several times a day, for instance, wherein a farming operation comprises several parcels of land to be harvested, and the combine must be driven over roads or lanes from parcel to parcel, with the header removed. This can make header installation and removal a burdensome and time consuming task.

Installation of a header typically involves maneuvering the combine into a position wherein the feeder is positioned and oriented in a special manner for engaging lifting elements on the feeder and header. Such lifting elements typically include at least one receiver such as a hook, on an upper portion of a front end of the feeder, which is configured for cooperatively or pivotally receiving and engaging at least one structural element on an upper portion of a rear end of the header, which structural element can include, for instance, a pin, an edge, or a beam. The lifting elements, are typically located adjacent to, or form parts of, interface or face plate structures bounding or framing an inlet opening of the feeder, and a discharge opening of the header, which openings are mated together for the passage of crop material from the header to the feeder.

Such special manner of positioning of the feeder relative to the header typically involves tilting the feeder such that the hook can engage the pin, edge or beam on the header, and such that the lower portions of the feeder and the header are spaced apart, then raising the feeder to lift the header to more fully engage it with the hook and pivot the bottom portions together, thereby mating the openings. The feeder movements are made using an actuator or actuators such as a fluid cylinder. The front interface structure can also optionally be supported for controlled sideward or lateral tilting relative to the feeder.

A typical header will include at least one driven or powered element for execution of the crop harvesting function and conveying harvested crops to the discharge outlet, for instance, for a grain header, a sickle or other cutter, a reel, conveyor mechanisms, and one or more actuators for adjusting the position of the reel; and for a corn header, gathering chains, strippers, and conveyors. Such drive elements can be driven variously by a power take off from the engine of the harvester, or can include fluid or electric motors on the header itself. The actuators can be variously fluid or electrical powered. Additionally, the header can include one or more sensors and/or controllers that are required to be connected to a system or systems of the combine for providing feedback and/or controlling various of the drivers and/or actuators, providing header recognition functions, and/or for sensing one or more parameters, such as a position of the header itself, or an element thereof. As a result, connection of various of these apparatus on the header to a source of pressurized fluid and a return reservoir on the harvester, and to a source of electrical power and/or the required system or systems, is required.

Representative known apparatus for jointly making fluid and electrical connections and couplings for various of these devices and systems utilizing mating coupler blocks, are illustrated in Cooksey et al. U.S. Pat. No. 6,519,923, entitled System For Coupling, Uncoupling And Controlling The Header Assembly In An Agricultural Combine, issued Feb. 18, 2003; and Watts et al. U.S. Pat. No. 6,735,929, entitled Multi-function Latch For A Combine.

A shortcoming, however, of the apparatus of each of the above referenced patents, is that the operator is required to exit the operator cabin of the harvesting machine and manually make the connections or couplings, which can be disadvantageous in terms of both productivity and operator satisfaction.

Accordingly, what is sought is apparatus and a method for automatically connecting electrical and hydraulic systems, respectively, of a header and an agricultural harvester which provides hands-free, automatic coupling of couplers or connectors of the respective systems, as the header is installed on the harvester, and also hands-free, automatic decoupling and disconnection when that header is removed, so as to be advantageous productivity-wise and satisfaction-wise.

### SUMMARY OF THE INVENTION

What is disclosed is apparatus and a method for automatically connecting electrical and hydraulic systems, respectively, of a header and an agricultural harvester which provides hands-free, automatic coupling of couplers or connectors of the respective systems, as the header is installed on the harvester, and also hands-free, automatic decoupling and disconnection when that header is removed, so as to be advantageous productivity-wise and satisfaction-wise.

According to a preferred embodiment of the invention, the harvester includes a self-propelled frame having a forward end including a feeder having a front end portion having a forwardly facing inlet opening for receiving a flow of harvested crops. The feeder has a front interface structure bounding the inlet opening, and apparatus controllably operable for moving the front end portion of the feeder upwardly and downwardly relative to the frame. The header has a front end portion including harvesting apparatus controllably operable for harvesting crops from a field, and conveyor apparatus for conveying the harvested crops to a center region of the header. The center region has a discharge opening through which the harvested crops will be discharged rearwardly by the conveyor apparatus, and the header has a rear interface structure bounding the discharge opening. The front interface structure of the feeder and the rear interface structure of the header include lifting elements, respectively, which are pivotably engageable when brought together in a predetermined manner with the lower portions of the interface structures spaced apart, such that when the feeder is moved upwardly with the lifting elements cooperatively engaged and the lower portions of the interface structures spaced apart, the header will be lifted by the feeder and the lower portions of the interface structures will be relatively pivoted into at least substantially abutting relation to align the discharge opening and the inlet opening for passage of harvested crop material therethrough. The invention includes a first coupler block supported on the feeder and including at least one fluid coupler and at least one electrical contact, and a second coupler block supported on the header and including at least one fluid coupler and at least one electrical contact, the fluid couplers on the first coupler block and on the second coupler block being configured and positioned, respectively, so as to couple, and the electrical contacts on the coupler blocks are configured and positioned to be brought into contact, as the interface structures are relatively pivoted into the at least substantially abutting relation.

According to a preferred method of the invention, the fluid couplers are coupled and the electrical contacts are brought into contact, as the interface structures are relatively pivoted into the at least substantially abutting relation. And, the fluid couplers are decoupled and the electrical contacts broken, as the interface structures are relatively pivoted from the at least substantially abutting relation, as the header is removed.

### BRIEF DESCRIPTION OF THE DRAWINGS

FIG. 1 is a side view of an agricultural combine and a header connectable thereto, including apparatus operable according to a method of the invention for automatically connecting electrical and hydraulic systems of the combine and header as the header is connected to a feeder of the combine;

FIG. 2 is another side view of the combine of FIG. 1 with the header connected to the feeder, and showing the electrical and hydraulic systems connected by the apparatus of the invention;

FIG. 3 is an enlarged fragmentary side view of the feeder of the combine of FIGS. 1 and 2 oriented in a position for pivotal engagement of lifting elements thereof with lifting elements of the header illustrated in dotted lines, and showing associated aspects of the apparatus of the invention;

FIG. 4 is another enlarged fragmentary side view of the feeder, showing engagement of the lifting elements for connection of the header, and the apparatus of the invention automatically connecting electrical and hydraulic systems of the combine and header;

FIG. 5 is an enlarged schematic front view of the feeder and the apparatus of the invention;

FIG. 6 is an enlarged schematic rear view of the header and the apparatus of the invention;

FIG. 7 is an enlarged rear view of aspects of the apparatus of the invention mounted on a side of the feeder;

FIG. 8 is another enlarged side view showing initiation of the pivotal engagement of the lifting elements and associated initial positioning of elements of the apparatus of the invention;

FIG. 9 is another enlarged side view showing the lifting elements of the feeder and header fully engaged and apparatus of the invention automatically connected together for coupling fluid and electrical systems of the feeder and header;

FIG. 10 is a fragmentary simplified schematic side view of initial coupling of aspects of the apparatus of the invention as the feeder and header are being relatively pivotally moved toward one another;

FIG. 11 is another fragmentary simplified schematic side view of the aspects of the apparatus of the invention during further pivoting together of the feeder and header; and

FIG. 12 is still another fragmentary simplified schematic side view showing the aspects of the apparatus of the invention coupled together when the feeder and the header are fully connected.

### DETAILED DESCRIPTION OF THE INVENTION

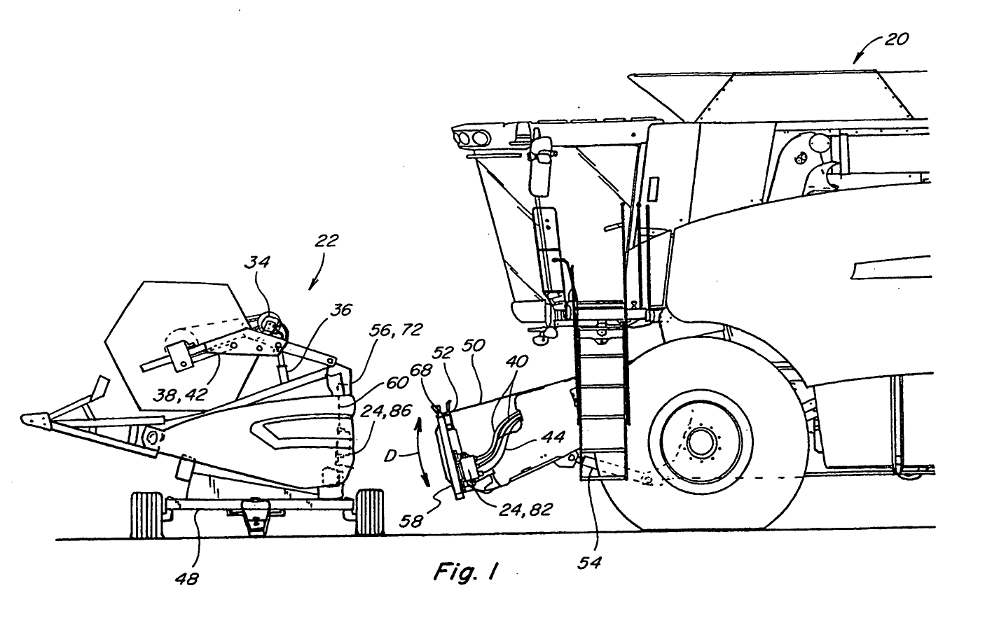

Referring now to the drawings, and particularly to FIG. 1, a self-propelled agricultural combine 20 of conventional, well-known construction, is illustrated in association with a header 22 also of conventional, well-known construction. Header 22 is connectable to combine 20 in the well-known manner, and both include apparatus 24 of the present invention for automatically connecting fluid systems and electrical systems, respectively, thereof, during the connection of the header to the combine. Apparatus 24 of the invention is also operable for automatically disconnecting the respective fluid and electrical systems, when header 22 is disconnected from combine 20.

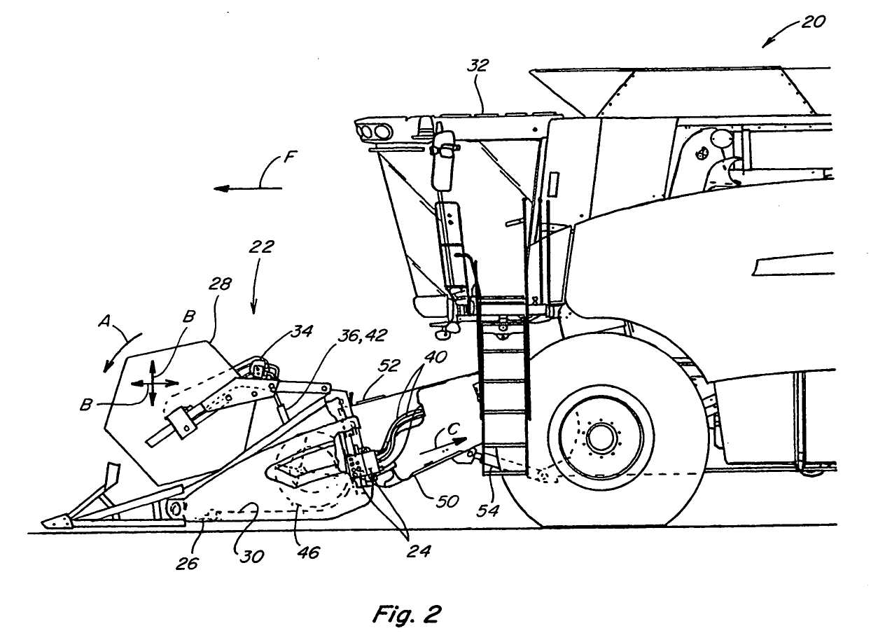

Referring also to FIG. 2, header 22 illustrated is of the variety known as a grain header, and is configured for harvesting small grains, such as, but not limited to, wheat, soybeans and other legumes, and rice, as combine 20 is moved in a forward direction, denoted by arrow F over an agricultural field. Header 22 is intended to be representative of a wide variety of different headers of various widths that can be used with a combine such as combine 20, such as, but not limited to, corn headers and specialty grain headers. Header 22 includes harvesting apparatus including an elongate, sidewardly extending sickle 26 reciprocatingly operable for severing crops from a field, and a reel 28 rotatable, as denoted by arrow A, for feeding the crops to sickle 26 and conveying the cut crops rearward onto a pan 30 of the header. Sickle 26 can be powered in any suitable manner, for instance, using a fluid motor which receives pressurized fluid from a pressurized fluid source, such as a pump, on combine 20; a PTO drive; or an electric motor, in the well-known, conventional manner (not shown).

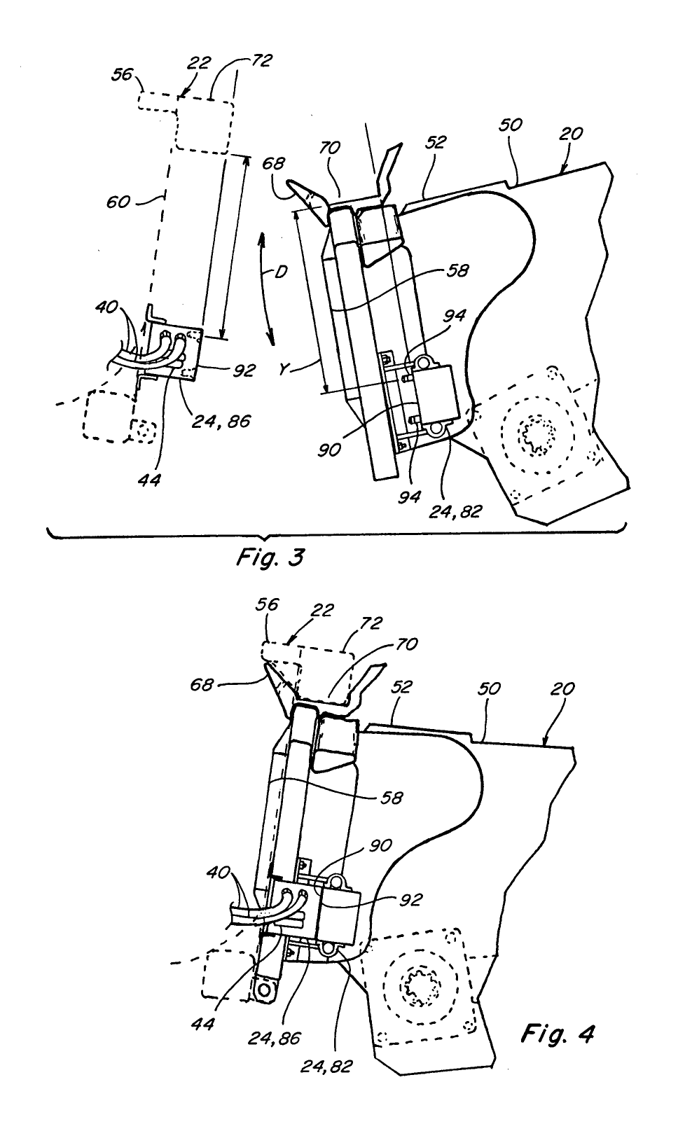

The speed of rotation of reel 28 is continuously controllable during the harvest operation by an operator in operator cabin 32 using a control (not shown), and the reel will be controllably movable in upward, downward, forward and rearward directions as denoted by directional arrows B, in the well-known, conventional manner, for achieving desired crop harvesting characteristics. A representative fluid motor 34 for rotatably driving reel 28, and a representative fluid controlled actuator 36 for controlling vertical position of the reel, are illustrated. Motor 34 and actuator 36 are conventionally constructed and operable hydraulic devices comprising elements of a fluid system of header 22, which elements will variously receive pressurized fluid from the pump on combine 20, and will return fluid to a reservoir on the combine, through fluid lines 40 (see also FIGS. 3 and 4) in the well-known manner, and which will be automatically coupled together by apparatus 24 of the invention, when header 22 is connected to combine 20 as illustrated in FIGS. 2 and 4, as will be explained. Additional actuators for effecting forward and rearward movements of reel 28 are concealed by telescopically extendable reel support arms 38, and will also be connected via connection of associated fluid lines 40 of the header and combine.

Header 22 will also include electrical devices which comprise elements of an electrical system of the header, which devices can include, but are not limited to, sensors such as a speed sensor 42 associated with fluid motor 34, various position sensors, and the like. The electrical devices of the electrical system will likewise be connected to corresponding systems of combine 20, via connection of a wiring harness 44 of the header with a wiring harness 44 of the combine by apparatus 24 of the invention, as will be explained. Here, it should be noted that fluid lines 40 and harness 44 are deleted from various of the FIGS. for clarity.

Other devices and/or mechanisms of header 22 that can be powered via connection to combine 20 using apparatus 24 of the invention can include, but are not limited to, conveyor apparatus, illustrated by an auger 46 extending substantially the width of header 22, which is rotatable for conveying the harvested crops toward a center region of the header for passage through a discharge opening 64 thereof (FIG. 6), and a device (not shown) for providing identification or recognition of the header when connected to the combine.

In FIG. 1, header 22 is shown supported on a conventional wheeled header cart 48 towable by combine 20 or another vehicle, for transporting the header when disconnected from combine 20, from location to location, such as between fields and the like.

Combine 20 includes a feeder 50 operable for receiving harvested crops from a header, such as header 22, connected to a front end 52 of the feeder, and conveying the crops rearwardly and upwardly within the feeder, as denoted by arrow C in FIG. 2, to a threshing system (not shown) located within the combine, in the well-known, conventional manner. Feeder 50 is pivotally supported for upward and downward movement of front end 52, as denoted by arrows D (FIGS. 1 and 3), by a lift cylinder 54, also in the well-known manner.

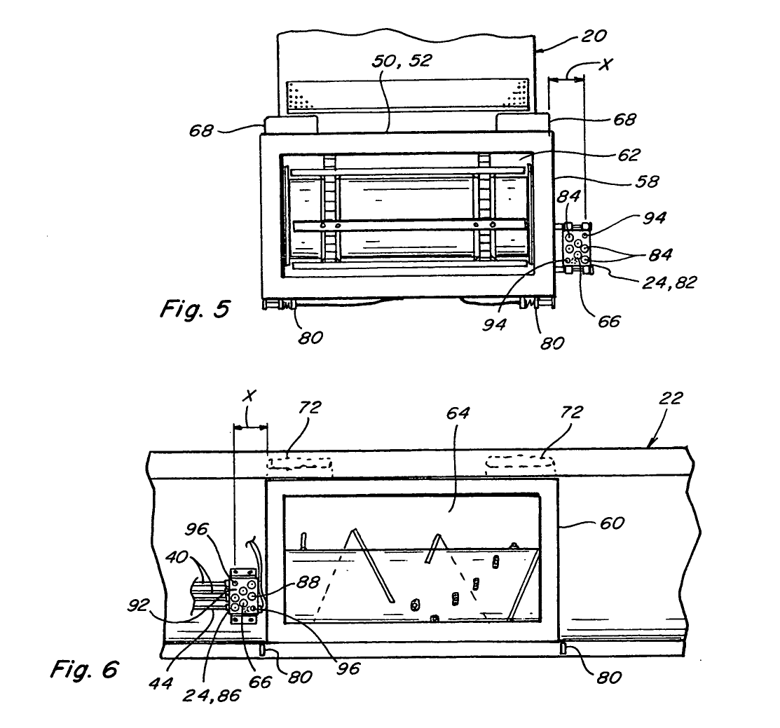

Referring also to FIGS. 5 and 6, front end 52 of feeder 50 includes a front interface structure 58, and a rear end 56 of header 22 includes a rear interface structure 60, which essentially comprise rectangular face plates that bound an inlet opening 62 on front end 52 and a discharge opening 64 on rear end 56, respectively, and which are matingly positionable in abutting relation, to provide a continuous passage for the crop material to flow between header 22 and feeder 50. This mating relationship is achieved by the connection of header 22 to feeder 50, as explained next. At the same time, the fluid lines 40 of header 22 will be automatically coupled to the corresponding fluid lines 40 of combine 20, and electrical contacts 66 of wiring harnesses 44 of the header and combine are automatically connected, by the connection or coupling of apparatus 24 of the invention, as is also explained.

Front end 52 of header 50 includes lifting elements 68 mounted adjacent to opposite sides of an upper end of front interface structure 58, which lifting elements 68 are each preferably an upwardly open hook shaped member defining an elongate, receptacle 70 of rectangular or other suitable sectional shape. Rear end 56 of header 22 includes lifting elements 72 disposed adjacent to opposite sides of an upper end of rear interface structure 60, which lifting elements 72 preferably comprise sidewardly extending rectangular pins or rods which are cooperatively and pivotally engageable with lifting elements 68, so as to be receivable and positionable within respective receptacles 70 when header 22 is connected to feeder 50 and interface structures 58 and 60 are in the proper abutting relation.

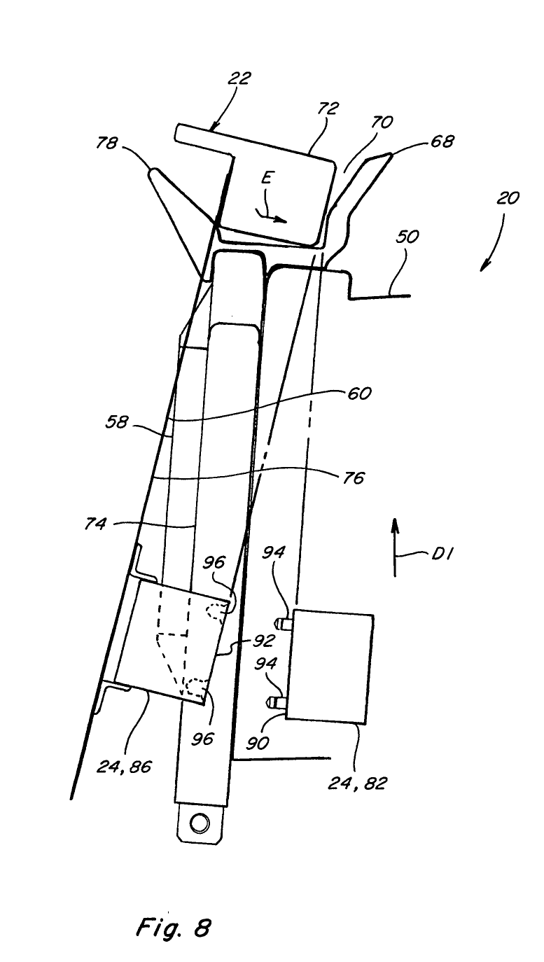

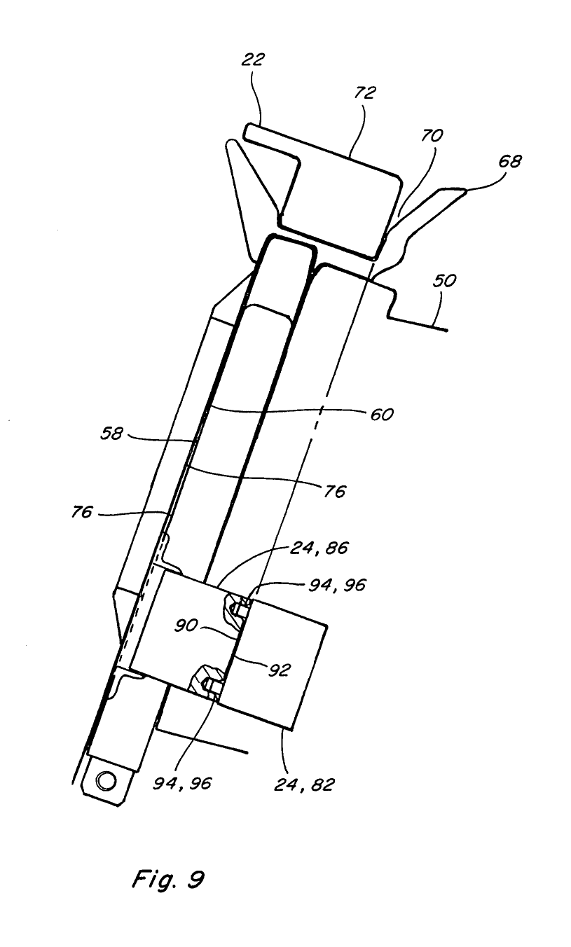

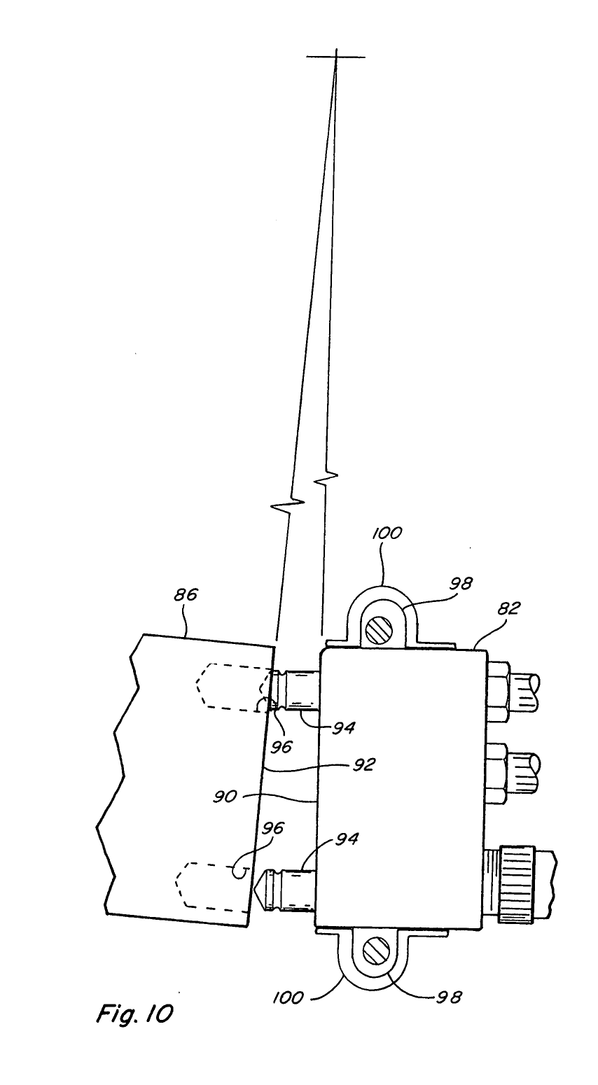

Referring also to FIG. 8, in operation, lifting elements 72 are initially pivotally engageable with lifting elements 68, by the upward movement of feeder 50, as effected by operation of lift cylinder 54, when combine 20 is properly positioned in relation to header 22, as illustrated. It should be noted here that, during this initial engagement, the feeder will be angularly oriented or tilted relative to the header, such that a lower portion 74 of front interface structure 58 will be spaced apart from a lower portion 76 of rear interface structure 60, which will facilitate insertion of a forwardmost edge 78 of lifting elements 68 into a space forwardly of lifting elements 72 of the header to enable initiation of the connection. Then, by continued upward movement of feeder 50, as denoted by arrow D1, header 22 will be lifted, such that lifting elements 72 will be pivoted within receptacle 70, as denoted by arrow E, so as to be fully cooperatively received or seated in the receptacle, as illustrated in FIGS. 4 and 9. During this pivoting movement, lower portions 74 and 76 are relatively pivotally moved toward one another, until interface structures 58 and 60 are in the desired abutment. Header 22 can now be releasably latched in this position, for instance, using a conventional latch mechanism 80 (FIGS. 5 and 6) in the conventional manner to be fully and completely mounted on feeder 50.

Apparatus 24 of the invention includes a first coupler block 82 supported on front end 52 of feeder 50 and including a plurality of fluid couplers 84, connected respectively, with fluid lines 40 of the combine, and a plurality of electrical contacts 66. Apparatus 24 includes a second coupler block 86 supported on rear end 56 of header 22, and including a plurality of fluid couplers 88, connected respectively, with fluid lines 40 of the header, and a plurality of electrical contacts 66.

Here, fluid couplers 84 are located on a forwardly facing surface 90 of coupler block 82, and fluid couplers 88 are located on a rearwardly facing surface 92 of coupler block 86, and are arranged in predetermined positions, such that predetermined ones of couplers 84 will couple to form a high-pressure, fluid sealed connection with corresponding couplers 88, when surfaces 90 and 92 are brought into abutting relation. Preferably, couplers 84 and 86 are well-known, commercially available varieties of fluid couplers. Similarly, electrical contacts 66 are located on surfaces 90 and 92 in predetermined positions, so as to make electrical contact in the appropriate manner when surfaces 90 and 92 are brought into the abutting relation. For instance, contacts 66 on one or both coupler blocks can be spring-loaded devices, as are also well known and commercially available.

Surface 90 of coupler block 82 additionally includes at least one, and preferably two, aligning pins 94 extending forwardly from predetermined locations thereon, which pins 94 are slidably receivable within aligning holes 96 at predetermined locations in surface 92 of block 86, as lower portions 74 and 76 of header 22 and feeder 50 are pivoted together. Preferably in this regard, coupler blocks 82 and 86 are located beside respective interface structures 58 and 60, as shown, in positions such that surfaces 90 and 92 will pivot into aligned abutment as the interface structures are brought together. For aligning purposes, for example, an upper one of aligning pins 94 is located a horizontal distance X from a reference, such as an outermost edge of the closest lifting element 72, and a vertical distance Y from a reference, such as a lower surface of receptacle 70 of the lifting element, and the upper one of aligning holes 96 is located corresponding horizontal and vertical distances X and Y from mating portions of the nearest lifting element 72. The lower ones of pins 94 and holes 96 will be predetermined distances from the upper pins and holes or other suitable references.

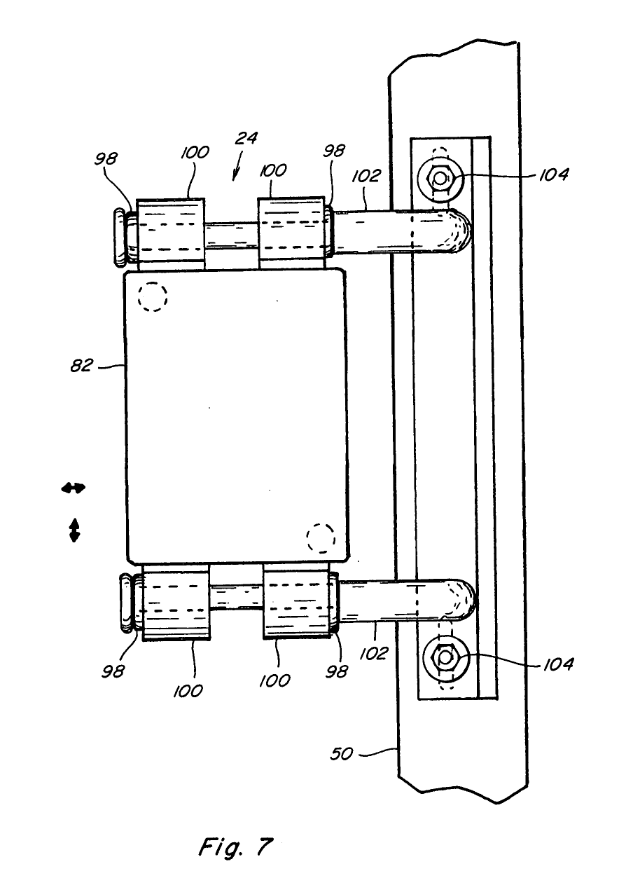

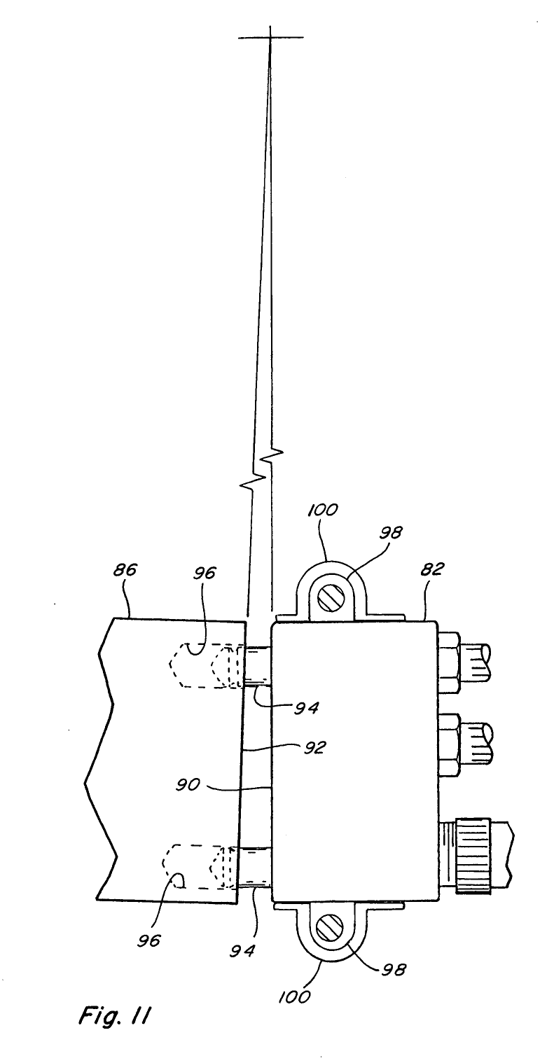

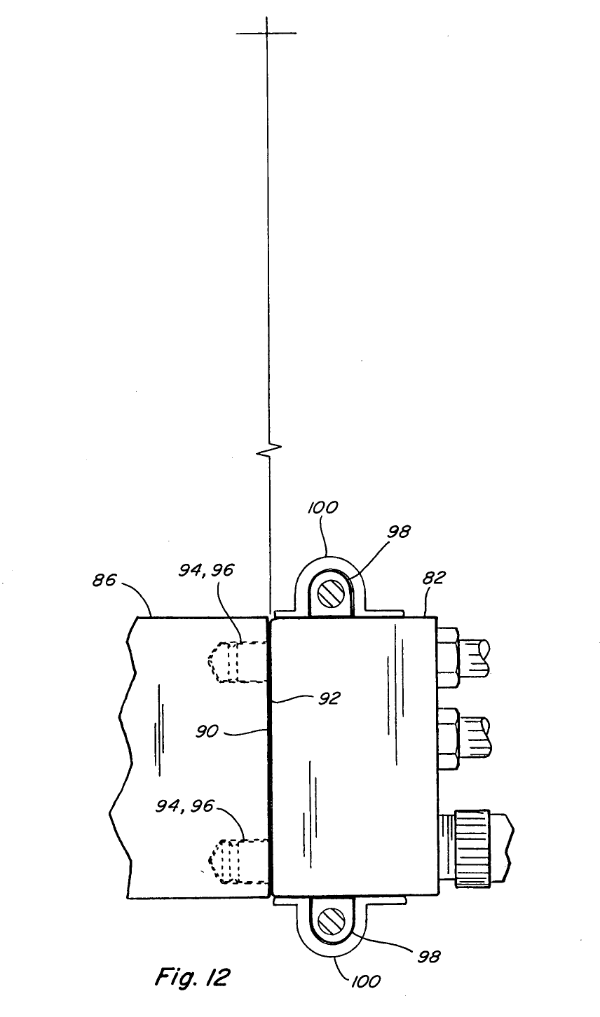

Referring more particularly to FIG. 7, and also to FIGS. 10, 11 and 12, one or both of coupler blocks 82 and 86, here represented by first coupler block 82, can optionally be supported by resilient elements, such as elements 98 illustrated, to allow some limited horizontal and vertical movement, and even some limited forward and/or rearward movement and/or tilting, relative to the feeder or the header from which it is supported, here, represented by the side of feeder 50, to facilitate alignment and slidable receipt of pins 94 in holes 96, as discussed next. The other of coupler blocks 82 and 86 can be suitably mounted, for instance using a rigid bracket. Each resilient element 98 can be, for instance, a rubbery bushing, captured in a bracket 100 mounted on the coupler block, and which receives a rod 102 suitably connected to the side of feeder 50, for instance, using fasteners 104. FIGS. 10, 11 and 12, best illustrate the relative pivoting motions for bringing together of blocks 82 and 86, to bring surfaces 90 and 92 into abutting relation, and for automatically coupling the couplers 84 and 88 (FIGS. 5 and 6), and bringing electrical contacts 66 (also FIGS. 5 and 6) together, as the header is connected to the feeder in the above-described manner. These FIGS., when viewed in the reverse order also illustrate the relative pivoting motions for uncoupling.

While a preferred embodiment of the invention has been described, it should be understood that the invention is not so limited, and modifications may be made without departing from the invention. The scope of the invention is defined by the appended claims, and all devices that come within the meaning of the claims, either literally or by equivalence, are intended to be embraced therein.

What is claimed is:

1. An agricultural harvesting machine, comprising:
a self-propelled frame having a forward end including a feeder having a front end portion having a forwardly facing inlet opening for receiving a flow of harvested crops, a front interface structure bounding the inlet opening, and apparatus controllably operable for moving the front end portion of the feeder upwardly and downwardly relative to the frame;
an elongate header including a front end portion including harvesting apparatus controllably operable for harvesting crops from a field, and conveyor apparatus for conveying the harvested crops to a center region of the header, the center region including a discharge opening through which the harvested crops will be discharged rearwardly by the conveyor apparatus, and the header including a rear interface structure bounding the discharge opening;
the front interface structure of the feeder and the rear interface structure of the header including lifting elements, respectively, which are pivotably engageable when brought together in a predetermined manner with the lower portions of the interface structures spaced apart, such that when the feeder is moved upwardly with the lifting elements cooperatively engaged and the lower portions of the interface structures spaced apart, the header will be lifted by the feeder and the lower portions of the interface structures will be relatively pivoted into at least substantially abutting relation to align the discharge opening and the inlet opening for passage of harvested crop material therethrough;
a first coupler block supported on the feeder and including at least one fluid coupler and at least one electrical contact; and
a second coupler block supported on the header and including at least one fluid coupler and at least one electrical contact;
wherein the fluid couplers on the first coupler block and on the second coupler block are configured and positioned, respectively, so as to couple, and the electrical contacts on the coupler blocks are configured and positioned to be brought into contact, as the interface structures are relatively pivoted into the at least substantially abutting relation.

2. The harvesting machine of claim 1, wherein at least one of the coupler blocks is supported for resilient sideward movement.

3. The harvesting machine of claim 1, wherein the fluid couplers and the electrical contacts are disposed on the coupler blocks so face in a direction of pivotal movement of the header and the feeder.

4. The harvesting machine of claim 1, wherein the first and the second coupler blocks are supported adjacent to sides of the front and the rear interface structures, respectively.

5. The harvesting machine of claim 1, further comprising apparatus for releasably latching the header to the feeder when the interface structures are in the at least substantially abutting relation.

6. The harvesting machine of claim 1, wherein one of the coupler blocks includes at least one aligning pin slidably receivable in a hole in the other of the coupler blocks as the interface structures are pivoted into the at least substantially abutting relation.

7. The harvesting machine of claim 6, wherein at least one of the coupler blocks is resiliently supported so as to be movable to a limited extent to allow the slidable receipt of the at least one aligning pin in the hole.

8. The harvesting machine of claim 1, wherein the lifting elements comprise at least one hook on the feeder, and a structure on the header cooperatively receivable within the hook.

9. The harvesting machine of claim 1, wherein the fluid couplers on the first coupler block and on the second coupler block are configured so as to automatically uncouple, as the interface structures are relatively pivoted away from the at least substantially abutting relation.

10. Apparatus for automatically coupling fluid systems and electrical systems, respectively, of a header and a feeder of an agricultural combine as the header is lifted by the feeder for coupling together therewith, comprising:
a lifting element on a front upper portion of a feeder configured for pivotally engaging a lifting element on a rear upper portion of a header as the lifting element of the feeder is moved upwardly into contact with the lifting element on the header with lower portions of the feeder and the header spaced apart, the lifting elements being further configured such that when pivotally engaged and the upward movement of the feeder is continued, the header will be lifted by the feeder and pivoted so as to bring the lower portions of the feeder and the header together;
a first coupler block supported on the feeder and including at least one fluid coupler and at least one electrical contact; and
a second coupler block supported on the header and including at least one fluid coupler and at least one electrical contact;
wherein the fluid couplers on the first coupler block and on the second coupler block are configured and positioned, respectively, so as to couple, and the electrical contacts on the coupler blocks are configured and positioned to be brought into contact, as the lower portions of the feeder and the header are brought together.

11. The apparatus of claim 10, wherein at least one of the coupler blocks is supported for resilient sideward movement.

12. The apparatus of claim 10, wherein the fluid couplers and the electrical contacts are disposed on the coupler blocks so face in a direction of pivotal movement of the header and the feeder.

13. The apparatus of claim 10, wherein the first and the second coupler blocks are supported adjacent to sides of front and rear interface structures of the header and the feeder, respectively.

14. The apparatus of claim 13, further comprising apparatus on the feeder and the header operable for releasably latching the header to the feeder when the interface structures are in the at least substantially abutting relation.

15. The apparatus of claim 10, wherein one of the coupler blocks includes at least one aligning pin slidably receivable in a hole in the other of the coupler blocks as the lower portions of the feeder and the header are brought together.

16. The apparatus of claim 15, wherein at least one of the coupler blocks is resiliently supported so as to be movable to a limited extent to allow the slidable receipt of the at least one aligning pin in the hole.

17. The apparatus of claim 10, wherein the lifting elements comprise at least one hook on the feeder, and a structure on the header cooperatively receivable within the hook.

18. The apparatus of claim 10, wherein the fluid couplers on the first coupler block and on the second coupler block are configured so as to automatically uncouple as the lower portions of the feeder and the header are separated.

19. A method for automatically coupling fluid systems and electrical systems, respectively, of a header and a feeder of an agricultural combine, comprising steps of as the header is lifted by the feeder for coupling together therewith, comprising:
providing a lifting element on a front upper portion of a feeder configured for pivotally engaging a lifting element on a rear upper portion of a header as the lifting element of the feeder is moved upwardly into contact with the lifting element on the header with lower portions of the feeder and the header spaced apart, the lifting elements being further configured such that when pivotally engaged and the upward movement of the feeder is continued, the header will be lifted by the feeder and pivoted so as to bring the lower portions of the feeder and the header together;
providing a first coupler block supported on the feeder and including at least one fluid coupler and at least one electrical contact, and a second coupler block supported on the header and including at least one fluid coupler and at least one electrical contact, the fluid couplers on the first coupler block and on the second coupler block being configured and positioned, respectively, so as to couple, and the electrical contacts on the coupler blocks being configured and positioned so as to be brought into contact, as the lower portions of the feeder and the header are brought together; and
moving the lifting element of the feeder upwardly into contact with the lifting element on the header with lower portions of the feeder and the header spaced apart, and continuing the upward movement of the feeder to lift and pivot the header to bring the lower portions of the feeder and the header together so as to couple the couplers and bring the electrical contacts into contact.

20. The method of claim 19, wherein at least one of the coupler blocks is supported for resilient movement relative to the other of the coupler blocks.

21. The method of claim 19, wherein the fluid couplers and the electrical contacts are disposed on the coupler blocks so face in a direction of pivotal movement of the header and the feeder.

22. The method of claim 19, wherein the first and the second coupler blocks are supported adjacent to sides of front and rear interface structures of the header and the feeder, respectively.

23. The method of claim 19, comprising a further step of latching the feeder to the header when the lower portions thereof are brought together.

24. The method of claim 19, wherein the lifting elements comprise at least one hook on the feeder, and a structure on the header cooperatively receivable within the hook.

25. The method of claim 19, wherein the fluid couplers on the first coupler block and on the second coupler block are configured so as to automatically uncouple as the lower portions of the feeder and the header are separated.
